(19) United States
(12) Patent Application Publication
(10) Pub. No.: US 2005/0046735 A1
(43) Pub. Date: Mar. 3, 2005

(54) Digital image capturing module assembly and method of fabricating the same

(75) Inventors: Kah-Ong Tan, Taipei (TW); Peter Tao, Taipei (TW); Gui-Cheng Ni, Taipei (TW)

Correspondence Address: EDWARDS & ANGELL, LLP, P.O. BOX 55874, BOSTON, MA, 02205, US

(73) Assignee: Inventec Micro-Electronics Corporation

(21) Appl. No.: 10/651,508

(22) Filed: Aug. 29, 2003

(51) Int. Cl. H04N 5/225

(52) U.S. Cl. 348/340

(57) ABSTRACT

A digital image capturing module assembly and method of fabricating the same is proposed, which is used to fabricate a digital image capturing module assembly from a photosensitive printed circuit board and a lens holder. The proposed assembly method is characterized by the attachment of a light-impenetrable reinforcement plate to the photosensitive printed circuit board to provide both a light-impenetrable effect and an reinforcement effect to the photosensitive printed circuit board, which allows the enclosed photosensitive device to be shielded from sidelight and backlight, and further allows the photosensitive printed circuit board to be reinforced in structural strength that can prevent it from deformation or cracking during fabrication and transportation. This feature allows the finished product of digital image capturing module to be more assured in its optical quality of captured images during actual application, and also allows the fabrication thereof to have a high rate of yield during assembly.

### BACKGROUND OF THE INVENTION

1. Field of the Invention

This invention relates to electronics assembly technology, and more particularly, to a digital image capturing module assembly and method of fabricating the same, which is designed for use to assemble a digital image capturing module from a lens holder and a photosensitive printed circuit board (PCB), such as a CCD (Charge Coupled Device) or CMOS (Complementary Metal Oxide Semiconductor) based PCB, and which is characterized by the attachment of a light-impenetrable reinforcement plate to the back surface of the photosensitive printed circuit board to provide both a light-impenetrable effect and an reinforcement effect to the photosensitive IC device mounted on the photosensitive printed circuit board.

2. Description of Related Art

Digital image capturing module is a key component in the assembly of a digital still camera (DSC) or a camera-equipped electronic device such as mobile phone, which is composed of a lens holder and a sheet-shaped photosensitive printed circuit board (PCB); wherein the lens holder is used to hold a lens unit that is used to capture an optical image and focus the captured image on a focusing plane on the rear of the lens holder, while the photosensitive printed circuit board is based on a photosensitive device, such as a CCD (Charge Coupled Device) photosensitive device or a CMOS (Complementary Metal Oxide Semiconductor) photosensitive device, which is disposed on the focusing plane of the lens holder for the purpose of converting the optical image focused thereon into digital form.

A conventional assembly method for the fabrication of a digital image capturing module is to provide an array of aligning posts on the periphery of the focusing plane on the lens holder and a corresponding array of aligning holes in the photosensitive printed circuit board to help align the photosensitive printed circuit board in position on the lens holder, and wherein the photosensitive printed circuit board is securely fixed in position by melting the tips of the aligning posts in addition to the use of an adhesive layer to adhere the photosensitive printed circuit board to the lens holder and provide a light-impenetrable effect at the junction between the photosensitive printed circuit board and the lens holder.

One drawback to the foregoing assembly method, however, is that the photosensitive printed circuit board is typically a flexible thin sheet, such as a polyimide (PI) sheet, having a thickness of only about 0.1 mm; and therefore, when the photosensitive printed circuit board is attached to the lens holder, it would be easily subjected to deformation or cracking during fabrication and transportation, which would result in a defective product of the digital image capturing module assembly. Moreover, since the photosensitive printed circuit board is quite thin in thickness, it would be transparent to backlight which could degrade the optical quality of the captured image by the digital image capturing module assembly during actual application. Still moreover, since the adhesive layer used to provide a light-impenetrable effect at the junction between the photosensitive printed circuit board and the lens holder could be unevenly coated, it could result in the formation of holes in the adhesive layer that allow sidelight to pass therethrough to the inside of the lens holder and degrade the optical quality of the captured image by the digital image capturing module assembly during actual application.

### SUMMARY OF THE INVENTION

It is therefore an objective of this invention to provide a new digital image capturing module assembly and method of fabricating the same which can help reinforce the photosensitive printed circuit board so as to prevent the photosensitive printed circuit board from deformation or cracking during fabrication and transportation and thereby allows the fabrication of digital image capturing modules to have a high rate of yield.

It is another objective of this invention to provide a digital image capturing module assembly and method of fabricating the same which allows the enclosed photosensitive device on the photosensitive printed circuit board to be shielded from sidelight and backlight that would otherwise degrade the optical quality of the captured image during actual application.

The digital image capturing module assembly and method of fabricating the same according to the invention is designed for use to assemble a digital image capturing module from a lens holder and a photosensitive printed circuit board mounted with a photosensitive device, such as a CCD (Charge Coupled Device) photosensitive device or a CMOS (Complementary Metal Oxide Semiconductor) photosensitive device.

The digital image capturing module assembly and method of fabricating the same according to the invention is characterized by the attachment of a light-impenetrable reinforcement plate to the back surface of the photosensitive printed circuit board to provide both a light-impenetrable effect and an reinforcement effect to the photosensitive printed circuit board, which allows the enclosed photosensitive device on the photosensitive printed circuit board to be shielded from sidelight and backlight, and further allows the photosensitive printed circuit board to be reinforced in structural strength that can prevent the photosensitive printed circuit board from deformation or cracking during fabrication and transportation. This feature allows the finished product of digital image capturing module to be more assured in its optical quality of captured images during actual application, and also allows the fabrication of digital image capturing modules to have a high rate of yield during assembly.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an exploded perspective view of the various constituent parts used to fabricate a digital image capturing module assembly according to the invention;

FIG. 2 is a schematic diagram showing a sectional view of the exploded digital image capturing module assembly shown in FIG. 1 cutting through the line A-A;

FIG. 3 is a schematic sectional diagram used to depict the attachment of a light-impenetrable reinforcement plate to a photosensitive printed circuit board viewing through the line A-A shown in FIG. 1 during the fabrication of the digital image capturing module according to the invention; and

FIG. 4 is a schematic sectional diagram showing the finished product of the digital image capturing module according to the invention viewing through the line A-A shown in FIG. 1.

### DETAILED DESCRIPTION OF PREFERRED EMBODIMENTS

The digital image capturing module assembly and method of fabricating the same according to the invention is disclosed in full details by way of preferred embodiments in the following with reference to the accompanying drawings.

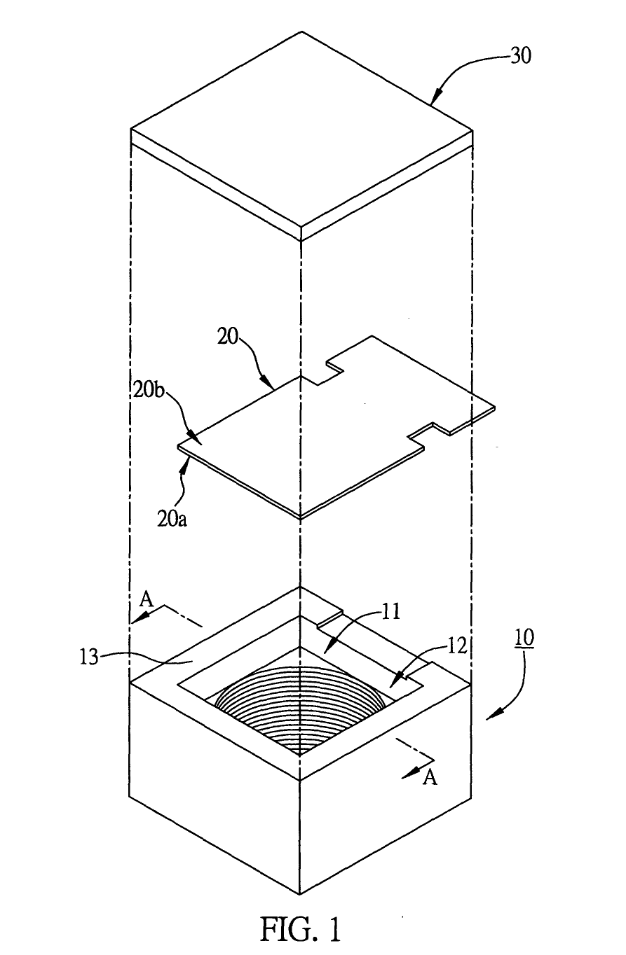

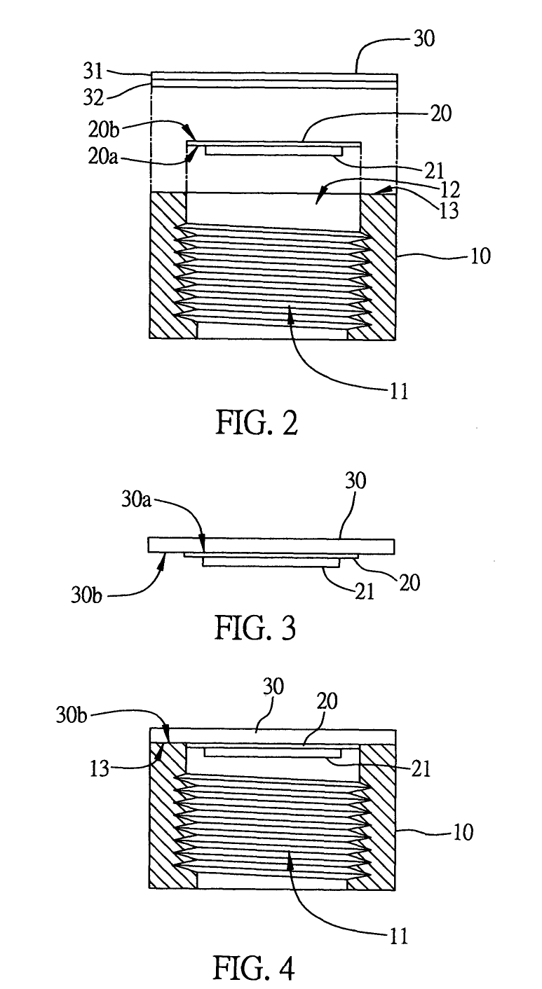

Referring first to FIG. 1 together with FIG. 2, the initial step in the assembly of a digital image capturing module according to the invention is to prepare a lens holder 10, a sheet-shaped photosensitive printed circuit board 20, and a light-impenetrable reinforcement plate 30.

The lens holder 10 is formed with a sidewall portion 13 which defines an inside hollowed portion 11 for the accommodation of a lens unit (not shown) therein, wherein the inside hollowed portion 11 has an open rear side defined as a focusing plane 12, and the lens unit is to be used to capture an optimal image and focus the captured image on the focusing plane 12 on the rear side of the lens holder 10.

The photosensitive printed circuit board 20 has a front surface 20a and an opposite back surface 20b, and whose front surface 20a is mounted with a photosensitive device 21 such as a CCD (Charge Coupled Device) based photosensitive device or a CMOS (Complementary Metal Oxide Semiconductor) based photosensitive device, which is to be used to convert the optical image captured by the lens unit (not shown) in the lens holder 10 into digital form. Moreover, as illustrated in FIG. 2, the photosensitive printed circuit board 20 should be dimensioned in such a manner that its surface area is smaller than the space confined within the lens holder's sidewall portion 13 on the periphery of the focusing plane 12. Typically, the photosensitive printed circuit board 20 has a thickness of about 0.1 mm and is made of a flexible material, such as polyimide (PI).

The light-impenetrable reinforcement plate 30 is flat in shape and rigid and light-impenetrable in structure, and which should be dimensioned to be greater in surface area than the photosensitive printed circuit board 20, and whose surface area should also be greater than the space confined within the lens holder's sidewall portion 13 on the periphery of the focusing plane 12. The light-impenetrable reinforcement plate 30 can be embodied in various manners, such as the one illustrated in FIG. 2 which is composed of a rigid sheet 31 and an opaque layer 32, wherein the rigid sheet 31 is made of an inflexible rigid material whose rigidity should be greater than that of the photosensitive printed circuit board 20, such as FR4, steel, aluminum, and so on; while the opaque layer 32 is, for example, a copper-made sheet coated with black ink, which is laminated to the rigid sheet 31 to provide a light-impenetrable effect to the rigid sheet 31.

Referring next to FIG. 3, during the assembly process, the first step is to securely attach the back surface 20b of the photosensitive printed circuit board 20 to the central area 30a of the light-impenetrable reinforcement plate 30 through the use of, for example, a hot-pressed adhesion method, but exposing the peripheral area 30b of the light-impenetrable reinforcement plate 30.

Referring further to FIG. 4, in the subsequent step, the combined piece of the photosensitive printed circuit board 20 and the light-impenetrable reinforcement plate 30 is mounted onto the lens holder 10, in such a manner that the photosensitive device 21 on the photosensitive printed circuit board 20 is enclosed within the inside hollowed portion 11 of the lens holder 10, and that the peripheral area 30b of the light-impenetrable reinforcement plate 30 is securely attached through the use of, for example, a hot-pressed adhesion method, to the sidewall portion 13 of the lens holder 10 on the periphery of the focusing plane 12. This completes the fabrication of the digital image capturing module assembly according to the invention.

On the finished product of the digital image capturing module assembly according to the invention, since the photosensitive printed circuit board 20 is dimensioned to have its surface area smaller than the space confined within the lens holder's sidewall portion 13 on the periphery of the focusing plane 12, it allows the photosensitive device 21 on the photosensitive printed circuit board 20 to be entirely enclosed within the inside hollowed portion 11 of the lens holder 10 so that the photosensitive device 21 is shielded from sidelight. Moreover, since the back surface 20b of the photosensitive printed circuit board 20 is fully covered by the light-impenetrable reinforcement plate 30, it allows the enclosed photosensitive device 21 to be shielded from backlight. Still moreover, since the light-impenetrable reinforcement plate 30 is made of an inflexible rigid material, it allows the photosensitive printed circuit board 20 to be reinforced in structural strength that can prevent the photosensitive printed circuit board 20 from deformation or cracking during fabrication and transportation, and therefore allows the fabrication of digital image capturing modules to have a high rate of yield.

In conclusion, the invention provides a digital image capturing module assembly and method of fabricating the same for use to assemble a digital image capturing module from a lens holder and a photosensitive printed circuit board, which is characterized by the attachment of a light-impenetrable reinforcement plate to the back surface of the photosensitive printed circuit board to provide both a light-impenetrable effect and an reinforcement effect to the photosensitive printed circuit board, which allows the enclosed photosensitive device on the photosensitive printed circuit board to be shielded from sidelight and backlight, and further allows the photosensitive printed circuit board to be reinforced in structural strength that can prevent the photosensitive printed circuit board from deformation or cracking during fabrication and transportation. This feature allows the finished product of digital image capturing module to be more assured in its optical quality of captured images during actual application, and also allows the fabrication of digital image capturing modules to have a high rate of yield during assembly. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A digital image capturing module assembly, which comprises:
a lens holder, which is formed with a sidewall portion defining a hollowed inside portion having an open side defined as a focusing plane;
a photosensitive printed circuit board, which has a back surface and an opposite front surface mounted with a photosensitive device, and whose surface area is smaller than the space confined within the lens holder's sidewall portion on the periphery of the focusing plane; and
a light-impenetrable reinforcement plate, which has a light-impenetrable structural quality and an inflexible rigid structural quality, and which has a surface area dimensioned to be greater in area than the surface area of the photosensitive printed circuit board and also greater than the space confined within the lens holder's sidewall portion on the periphery of the focusing plane; the light-impenetrable reinforcement plate having a central area securely attached to the back surface of the photosensitive printed circuit board and a peripheral area securely attached to the periphery of the focusing plane on the lens holder to enclose the photosensitive device within the hollowed inside portion of the lens holder.

2. The digital image capturing module assembly of claim 1, wherein the photosensitive printed circuit board is a CCD-based photosensitive printed circuit board.

3. The digital image capturing module assembly of claim 1, wherein the photosensitive printed circuit board is a CMOS-based photosensitive printed circuit board.

4. The digital image capturing module assembly of claim 1, wherein the light-impenetrable reinforcement plate includes:
a rigid sheet, which is greater in rigidity than the photosensitive printed circuit board to help reinforce the photosensitive printed circuit board; and
an opaque layer, which is laminated to the rigid sheet to provide a light-impenetrable effect to the rigid sheet.

5. The digital image capturing module assembly of claim 4, wherein the rigid sheet is made of a rigid material selected from the group comprising: FR4, steel, and aluminum.

6. The digital image capturing module assembly of claim 4, wherein the opaque layer is a copper-made sheet coated with black ink.

7. The digital image capturing module assembly of claim 1, wherein the light-impenetrable reinforcement plate is securely attached to the back surface of the photosensitive printed circuit board through the use of a hot-pressed adhesion method.

8. The digital image capturing module assembly of claim 1, wherein the light-impenetrable reinforcement plate is securely attached to the periphery of the focusing plane on the lens holder through the use of a hot-pressed adhesion method.

9. A method for fabricating a digital image capturing module, comprising:
preparing a lens holder, which is formed with a sidewall portion defining a hollowed inside portion having an open side defined as a focusing plane;
preparing a photosensitive printed circuit board, which has a back surface and an opposite front surface mounted with a photosensitive device, and whose surface area is smaller than the space confined within the lens holder's sidewall portion on the periphery of the focusing plane;
preparing a light-impenetrable reinforcement plate, which has a light-impenetrable structural quality and an inflexible rigid structural quality, and which has a surface area dimensioned to be greater in area than the surface area of the photosensitive printed circuit board and also greater than the space confined within the lens holder's sidewall portion on the periphery of the focusing plane;
attaching a central area of the light-impenetrable reinforcement plate to the back surface of the photosensitive printed circuit board; and
attaching a peripheral area of the light-impenetrable reinforcement plate to the periphery of the focusing plane on the lens holder to enclose the photosensitive device on the photosensitive printed circuit board within the hollowed inside portion of the lens holder.

10. The method of claim 9, wherein the photosensitive printed circuit board is a CCD-based photosensitive printed circuit board.

11. The method of claim 9, wherein the photosensitive printed circuit board is a CMOS-based photosensitive printed circuit board.

12. The method of claim 9, wherein the light-impenetrable reinforcement plate includes:
a rigid sheet, which is greater in rigidity than the photosensitive printed circuit board to help reinforce the photosensitive printed circuit board; and
an opaque layer, which is laminated to the rigid sheet to provide a light-impenetrable effect to the rigid sheet.

13. The method of claim 12, wherein the rigid sheet is made of a rigid material selected from the group comprising: FR4, steel, and aluminum.

14. The method of claim 12, wherein the opaque layer is a copper-made sheet coated with black ink.

15. The method of claim 9, wherein the light-impenetrable reinforcement plate is securely attached to the back surface of the photosensitive printed circuit board through the use of a hot-pressed adhesion method.

16. The method of claim 9, wherein the light-impenetrable reinforcement plate is securely attached to the periphery of the focusing plane on the lens holder through the use of a hot-pressed adhesion method.
